(19) United States
(12) Patent Application Publication
(10) Pub. No.: US 2024/0385881 A1
(43) Pub. Date: Nov. 21, 2024

(54) DISTRIBUTED COMMINICATION

(71) Applicant: ZHEJIANG LAB, Hangzhou (CN)

(72) Inventors: Hongsheng WANG, Hangzhou (CN); Guang CHEN, Hangzhou (CN); Feng LIN, Hangzhou (CN); Fei WU, Hangzhou (CN)

(21) Appl. No.: 18/456,921

(22) Filed: Aug. 28, 2023

(30) Foreign Application Priority Data
May 18, 2023 (CN) 202310561547.8

(51) Int. Cl. G06F 9/50

(52) U.S. Cl. CPC G06F 9/5016

(57) ABSTRACT

Methods, systems, apparatus, and computer-readable media for distributed communication are provided. In one aspect, a system includes: a first Dynamic Communication Network Object (DCNO) configured on a first device and a second DCNO configured on a second device. The second DCNO is configured to, based on a notification message sent by a first worknode, allocate a target memory to store the target data in a memory of the second device, generate a read request based on the target data and the target memory, and transmit the read request to the first DCNO. The first DCNO is configured to: based on one or more properties of the target data, retrieve the target data from a memory of the first device, and write the target data to the target memory in the second device. A second worknode is configured to perform one or more data processing tasks based on the target data.

### CROSS REFERENCE TO RELATED APPLICATIONS

The present application claims priority to Chinese Patent Application No. 202310561547.8 filed on May 18, 2023, and the entire content of the Chinese patent application is incorporated herein by reference.

### TECHNICAL FIELD

The present disclosure relates to computer technology, and in particular, to distributed communication.

### BACKGROUND

Automatically learning effective feature representations from data by using deep learning (DL), which improves the accuracy of prediction models, has been widely applied in fields such as speech recognition, image recognition, and object detection. In order to improve the performance of the trained predictive model, the number of training samples is increasing, which leads to a longer time for model training. To solve this problem, distributed training utilizing a plurality of worknodes to execute the same model training process in parallel may be adopted to reduce the time of model training and improve the model training speed.

In the distributed training process, respective worknodes pass data and gradient information to each other, which can generate a large amount of network communication. The current distributed communication solutions usually rely on the Central Processing Unit (CPU) to complete data transmission and protocol processing. The protocol processing involves a large amount of unnecessary data copying. Moreover, as the scale of the distributed training cluster becomes larger and larger, the network communication generated in the distributed training will multiply. However, this will occupy a large amount of CPU resources, resulting in low communication efficiency, and limiting the parallel scale and speed of neural network model training.

### SUMMARY

The present disclosure provides systems and methods for distributed communication that can at least partially solve the above problems.

One aspect of the present disclosure features a distributed communication system, and the system includes: a first worknode deployed on a first device, a second worknode deployed on a second device, a first Dynamic Communication Network Object (DCNO) configured on the first device, and a second DCNO configured on the second device. The first worknode is configured to: perform a data processing task assigned to itself to obtain target data; and send a notification message to the second DCNO, to notify the second device to read the target data. The second DCNO is configured to: allocate, in response to the notification message and according to one or more properties of the target data carried in the notification message, a target memory in memory of the second device; generate a read request according to the properties of the target data and the target memory, and send the read request to the first DCNO. The first DCNO is configured to: retrieve, in response to the read request and according to the properties of the target data parsed from the read request, the target data from memory of the first device; copy the target data to a pre-allocated specified registered memory; and write the target data stored in the specified registered memory to the target memory in the second device by performing a write operation. The second worknode is configured to: retrieve the target data from the target memory in the second device; and perform a data processing task assigned to itself according to the target data.

In some embodiments, a completion queue (CQ) is pre-created in the second device, and the CQ is used to store completed work requests (WR). In this case, the first DCNO is further configured to: generate specified information, where the specified information is used to notify the second DCNO that the target data has been written to the target memory in the second device; and write, in response to that the target data stored in the specified registered memory has been written to the target memory in the second device by performing a write operation, the specified information to the CQ in the second device. Accordingly, the second DCNO is further configured to: query the CQ in the second device, and determine whether the target data has been written to the target memory in the second device according to the specified information contained in the CQ.

In some embodiments, a CQ is pre-created in the second device, and the CQ is used to store completed WR. The first DCNO can be further configured to: divide the target data according to a preset data length to obtain multiple subdata segments; generate, for each of the subdata segments, specified information corresponding to the subdata segment, wherein the specified information is used to notify the second DCNO that the subdata segment has been written to the target memory in the second device; and write, in response to that each of the subdata segments from the target data stored in the specified registered memory has been written to the target memory in the second device in a sequence by performing write operations and in an order of the sequence for writing the subdata segments, the specified information corresponding to each of the subdata segments to the CQ in the second device. Accordingly, the second DCNO is further configured to: query the CQ in the second device; and determine, according to the specified information contained in the CQ whether each of the subdata segments from the target data has been written to the target memory in the second device.

In some embodiments, the second DCNO is further configured to: generate, in response to determining that the target data has been written to the target memory in the second device according to the specified information contained in the CQ, an acknowledgement (ACK) message; and send the ACK message to the first DCNO to notify the first DCNO to deallocate the memory occupied by the target data in the first device. Accordingly, the first DCNO is further configured to deallocate, in response to the ACK message sent by the second DCNO, the memory occupied by the target data in the first device.

In some embodiments, a first specified send memory and a second specified send memory are pre-allocated in the memory of the first device, a first specified receive memory and a second specified receive memory are pre-allocated in the memory of the second device, wherein, there is a correspondence between the first specified send memory and the first specified receive memory, there is a correspondence between the second specified send memory and the second specified receive memory. In this case, the first DCNO is further configured to: divide the target data into multiple subdata segments; copy, in response to determining that the first specified send memory and the first specified receive memory are both idle, a first subdata segment from the target data to the first specified send memory, and further write the first subdata segment to the first specified receive memory by performing a write operation; copy, in response to determining that the second specified send memory and the second specified receive memory are both idle, a second subdata segment from the target data to the second specified send memory, and further write the second subdata segment to the second specified receive memory by performing a write operation. Accordingly, the second DCNO is further configured to: retrieve the written first subdata segment from the first specified receive memory, and copy the retrieved first subdata segment to the target memory in the second device; retrieve the written second subdata segment from the second specified receive memory, and copy the retrieved second subdata segment to the target memory in the second device.

In some embodiments, the first DCNO is further configured to obtain, by invoking a remote procedure call in advance, information of the first specified receive memory and the second specified receive memory allocated in the second device to which the second DCNO belongs.

In some embodiments, the properties of the target data include length of the target data. Accordingly, the second DCNO is further configured to: determine a target length of the target memory according to the length of the target data carried in the notification message, wherein the target length is not less than the length of the target data; allocate, in the memory of the second device, the target memory of the target length.

In some embodiments, the first DCNO is further configured to: activate a message bus in the first device; determine, via the message bus in the first device, an identifier of the second device to receive the target data; send, in response to determining that an identifier of the first device to which the first DCNO belongs is different from the identifier of the second device, the target data to the second DCNO in the second device. Accordingly, the second DCNO is further configured to: receive the target data sent by the first DCNO; activate a message bus in the second device; determine, via the message bus in the second device, a message queue (MQ) corresponding to the second worknode; insert the target data into the MQ corresponding to the second worknode; send, by polling the MQ corresponding to the second worknode with a polling thread invoked in the second device, the target data in the MQ to the second worknode.

In some embodiments, the data processing task performed by the first worknode and the data processing task performed by the second worknode are determined based on respective computational subgraphs divided from a target computational graph, and there is an upstream and downstream relationship between them. Wherein, the target computational graph is determined based on an obtained target model, and includes at least one of a dynamic computational graph and a static computational graph; the upstream and downstream relationship is used to represent an input-output relationship between the respective computational subgraphs.

Another aspect of the present disclosure features a distributed communication method applied to a first DCNO configured on a first device. The method includes: retrieving, in response to the read request sent by a second DCNO configured on a second device and according to the properties of the target data parsed from the read request, the target data from memory of the first device; copying the target data to a pre-allocated specified registered memory; and writing the target data stored in the specified registered memory to target memory in the second device by performing a write operation, so that a second worknode deployed on the second device retrieves the target data from the target memory, and according to the retrieved target data, performs a data processing task assigned to the second worknode itself. Wherein the read request is generated by the second DCNO in response to a notification message sent by a first worknode deployed on the first device, according to the properties of target data carried in the notification message and target memory allocated for the target data.

In some embodiments, a CQ is pre-created in the second device, and the CQ is used to store completed WR. Accordingly, wherein, writing the target data stored in the specified registered memory to target memory in the second device, further includes: dividing the target data according to a preset data length to obtain multiple subdata segments; generating, for each of the subdata segments, specified information corresponding to the subdata segment, and the specified information is used to notify the second DCNO that the subdata segment has been written to the target memory in the second device; writing each of the subdata segments from the target data in the specified registered memory to the target memory in the second device in a sequence by performing write operations, and writing, in an order of the sequence for writing the subdata segments, the specified information corresponding to each of the subdata segments to the CQ in the second device, so that the second DCNO determines whether each of the subdata segments from the target data has been written to the target memory in the second device by querying the specified information contained in the CQ in the second device.

In some embodiments, a first specified send memory and a second specified send memory are pre-allocated in the memory of the first device, a first specified receive memory and a second specified receive memory are pre-allocated in the memory of the second device, wherein, there is a correspondence between the first specified send memory and the first specified receive memory, there is a correspondence between the second specified send memory and the second specified receive memory. Accordingly, the method further includes: dividing the target data into multiple subdata segments; copying, in response to determining that the first specified send memory and the first specified receive memory are both idle, a first subdata segment from the target data to the first specified send memory, and further writing the first subdata segment to the first specified receive memory by performing a write operation, so that the second DCNO retrieves the first subdata segment from the first specified receive memory, and copies the retrieved first subdata segment to the target memory in the second device; copying, in response to determining that the second specified send memory and the second specified receive memory are both idle, a second subdata segment from the target data to the second specified send memory, and further writing the second subdata segment to the second specified receive memory by performing a write operation, so that the second DCNO retrieves the second subdata segment from the second specified receive memory, and copies the retrieved second subdata segment to the target memory in the second device.

In some embodiments, the method further includes: activating a message bus in the first device, and then determining an identifier of the second device to receive the target data with the message bus in the first device; sending, in response to determining that an identifier of the first device to which the first DCNO belongs is different from the identifier of the second device, the target data to the second DCNO in the second device. Thus, the second DCNO may: receive the target data sent by the first DCNO; activate a message bus in the second device; determine a MQ corresponding to the second worknode with the message bus in the second device; insert the target data into the MQ corresponding to the second worknode; and send, by polling the MQ corresponding to the second worknode with a polling thread invoked in the second device, the target data in the MQ to the second worknode.

Another aspect of the present disclosure features a distributed communication method, applied to a second DCNO configured on a second device. The method includes: allocating, in response to a notification message sent by a first worknode deployed on a first device, according to one or more properties of target data carried in the notification message, target memory to store the target data in memory of the second device; generating a read request, according to the properties of the target data and the target memory, and sending the read request to a first DCNO configured on the first device. Wherein, the target data is obtained by the first worknode performing a data processing task assigned to itself, the notification message is generated according to the target data and sent by the first worknode. Thus, in response to receiving the read request, the first DCNO may: retrieve the target data from memory of a first device according to the properties of target data parsed from the read request; copy the target data to a pre-allocated specified registered memory; write the target data stored in the specified registered memory to the target memory in the second device by performing a write operation, so that a second worknode deployed on the second device performs a data processing task assigned to itself based on the target data in the target memory.

In some embodiments, according to the properties of target data carried in the notification message, allocating target memory to store the target data in memory of the second device, further includes: determining target length of target memory according to the length of the target data carried in the notification message, and the target length is not less than the length of the target data; allocating, in the memory of the second device, the target memory of the target length.

In some embodiments, the method further includes: receiving the target data sent by the first DCNO; activating a message bus in the second device; determining a MQ corresponding to the second worknode with the message bus in the second device; inserting the target data into the MQ corresponding to the second worknode; sending, by polling the MQ corresponding to the second worknode with a polling thread invoked in the second device, the target data in the MQ to the second worknode, so that the second worknode performs a data processing task assigned to itself based on the target data.

Another aspect of the present disclosure features a distributed communication apparatus, applied to a first device and configured as a first DCNO, wherein the apparatus includes: a target data determination module configured to, in response to a read request sent by a second DCNO configured on a second device, according to one or more properties of target data parsed from the read request, retrieve the target data from memory of a first device; a copy module configured to copy the target data to a pre-allocated specified registered memory; a first write module configured to write the target data stored in the specified registered memory to target memory in the second device by performing a write operation, so that a second worknode deployed on the second device retrieves the target data from the target memory, and according to the retrieved target data, performs a data processing task assigned to the second worknode itself. Wherein the read request is generated by the second DCNO in response to a notification message sent by a first worknode deployed on the first device, according to the properties of target data carried in the notification message and target memory allocated for the target data.

Another aspect of the present disclosure features a distributed communication apparatus, applied to a second device and configured as a second DCNO. The apparatus includes: a target memory allocation module configured to, in response to a notification message sent by a first worknode deployed on a first device, according to one or more properties of target data carried in the notification message, allocate target memory to store the target data in memory of a second device; a read request sending module configured to generate a read request according to the properties of the target data and the target memory, and send the read request to a first DCNO configured on the first device. Thus, in response to the read request, the first DCNO may: retrieve the target data from memory of a first device according to the properties of target data parsed from the read request, copy the target data to a pre-allocated specified registered memory, and write the target data stored in the specified registered memory to the target memory in the second device by performing a write operation, so that a second worknode deployed on the second device performs a data processing task assigned to itself based on the target data in the target memory. Wherein, the target data is obtained by the first worknode performing a data processing task assigned to itself, the notification message is generated according to the target data and sent by the first worknode.

Another aspect of the present disclosure features a computer-readable storage medium storing a computer program, wherein when the computer program is executed by a processor, the above distributed communication methods are implemented.

Another aspect of the present disclosure features an electronic device, including a memory, a processor, and a computer program stored in memory and executable on the processor, wherein when the processor executes the program, the above distributed communication methods are implemented.

In the distributed communication system provided in the present disclosure, the second DCNO, based on a notification message sent by the first worknode, allocates target memory to store the target data in the memory of the second device, generates a read request based on the target data and the target memory, and sends the read request to the first DCNO, thereby, the first DCNO, based on the properties of the target data obtained from the read request, retrieves the target data from the memory of the first device, and writes the target data to the target memory in the second device by performing a write operation, and the second worknode performs a data processing task based on the target data in the target memory. It can be seen that, with the interaction between the first dynamic network object and the second dynamic network object, direct communication across devices is realized, without need for a great deal of unnecessary data copy or occupying CPU resources, therefore improving communication efficiency and scaling up data parallelism. Note that the term “send” and “transmit” can be used interchangeably in the present disclosure.

Implementations of the above techniques include methods, systems, computer program products and computer-readable media. In one example, a method can include the above-described actions. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described actions.

The details of one or more disclosed implementations are set forth in the accompanying drawings and the description below. Other features, aspects, and advantages will become apparent from the description, the drawings and the claims.

### BRIEF DESCRIPTION OF DRAWINGS

The drawings described here are used to provide a further understanding of the present specification and constitute a part of the present disclosure. The schematic embodiments of the present disclosure and their descriptions are used to interpret the present disclosure, and do not constitute an improper limitation on the present disclosure. Among the drawings.

FIG. 1 is an architecture diagram of an example distributed communication system according to one or more embodiments of the present disclosure.

FIG. 2 is a flowchart of an example process of a distributed communication method according to one or more embodiments of the present disclosure.

FIG. 3 is a flowchart of an example process of a distributed communication method according to one or more embodiments of the present disclosure.

FIG. 4 is a flowchart of an example process of a distributed communication method according to one or more embodiments of the present disclosure.

FIG. 5 is a function module diagram of an example distributed communication apparatus according to one or more embodiments of the present disclosure.

FIG. 6 is a function module diagram of an example distributed communication apparatus according to one or more embodiments of the present disclosure.

FIG. 7 is a structure diagram of an example electronic device for distributed communication according to one or more embodiments of the present disclosure.

### DETAILED DESCRIPTION

To make the purpose, the technical solution, and the advantages of the present disclosure clearer, the technical solution of the present disclosure will be described clearly and comprehensively with reference to specific embodiments of the present disclosure and corresponding drawings. Obviously, the described embodiments are only a part, but not all, of the embodiments of the present disclosure. Based on the embodiments of the present disclosure, all other embodiments obtained by a person of ordinary skill in the art without creative efforts shall fall within the scope of protection of the present disclosure.

In addition, it should be noted that all actions to obtain signals, information, or data in the present disclosure are carried out in accordance with the corresponding data protection regulations and policies of the location, and authorized by the corresponding device owner.

Deep learning (DL) methods may be used to process data and obtain data processing results in a variety of fields. For example, in the field of speech recognition, the speech to be recognized may be input into the speech recognition model trained by the DL method, to determine the text corresponding to the speech that is to be recognized; in the image field, the image to be recognized may be input to the trained image recognition model, and the target image in the image to be recognized may be obtained. In order to further improve the performance of the model obtained by training, the current solution is to increase the scale of the samples used for model training, or to expand the scale of the model itself. No matter which solution mentioned above, due to the limited computing power of a single electronic device, it is impossible for a single electronic device to independently support the complete model training process or model reasoning process. Therefore, at present, it is possible to adopt distributed data processing using a plurality of worknodes (e.g., electronic devices) to perform the training or inference process of the same model in parallel to improve the speed and efficiency of data processing.

In the process of distributed data processing, data is transferred between respective worknodes, which will produce a large amount of network communication. Wherein network communication is often based on TCP/IP protocol to achieve, and traditional network communication based on TCP/IP protocol requires access of system kernel and network protocol stack, which involves a large amount of unnecessary data copying. Especially with the explosive growth of sample data sets, the sample dataset Batch Size grows geometrically, which not only makes communication inefficient, but also occupies a lot of CPU resources, limiting scale and speed of parallelism in distributed data processing solutions.

Based on this, in the distributed communication system provided in the present disclosure, Remote Direct Memory Access (RDMA) technology is adopted to improve communication efficiency by eliminating unnecessary data copying during data transmission. In RDMA, the network adaptor in the device is responsible for data reading and other operation logic, no longer requiring the CPU to participate in the data transmission process, avoiding occupying a large amount of CPU resources. Compared to traditional network communication, RDMA greatly improves network communication speed. Applying RDMA to distributed training or distributed reasoning of DL can speed up the data exchange process between nodes in the distributed training process and effectively improve the efficiency of distributed training or reasoning.

The technical solutions provided by the embodiments of the present disclosure will be described in detail below with reference to the drawings.

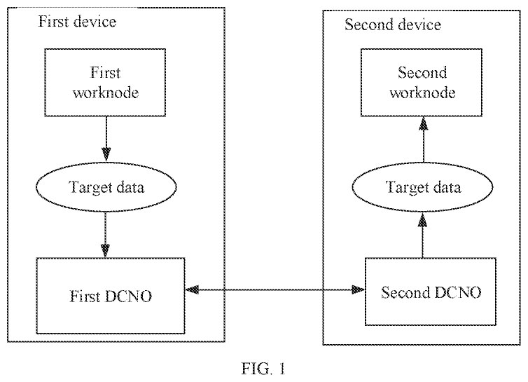

FIG. 1 is an architecture diagram of a distributed communication system provided in the embodiments of the present disclosure, the distributed communication system can be applied to various scenarios that require distributed data transmission, such as machine learning model training and inference. The following is only an example of a distributed systems applied to distributed model training, as a detailed illustration of the technical solution of the present disclosure.

In distributed model training, the computational efficiency of deep learning is improved by deploying deep learning tasks with a huge amount of computation and data on a plurality of worknodes for parallel execution. Specifically, in order to improve the execution speed of model training tasks, multiple worknodes may be configured in a distributed DL system to execute model training tasks in parallel. Respective worknodes can be deployed on different devices and are to, by using the hardware resources of the devices to perform the same model training task, handle model training tasks with massive training samples and large-scale model structures. When performing model training tasks in a distributed manner, a plurality of worknodes deployed on different machines execute model training tasks in parallel. The distributed mechanism of the plurality of worknodes can be data parallelism or model parallelism. A computing device can include at least one processor and at least one memory storing programming instructions executable by the at least one processor to perform one or more operations. A worknode can be a node that runs one or more applications on the computing device by using the at least one processor and the at least one memory.

In some embodiments, a worknode (e.g., the first worknode or the second worknode) can be an independent computing device, an independent CPU (Central Processing Unit), or GPU (graphics processing unit), or a divided computing unit on a CPU or a GPU.

In the present disclosure, taking the model parallelism as an example, a computational graph is generated based on the complete model structure of the model to be trained, the computational graph is divided into a plurality of computational subgraphs, and different computational subgraphs are assigned to different worknodes. Thus, the model structure is partitioned and stored on a plurality of worknodes, and respective worknodes sequentially perform the data processing tasks corresponding to respective computational subgraphs to carry out the distributed model training. Due to the fact that the respective worknodes can be deployed on different devices in a distributed cluster, there may be cross device communication situations.

For example, for the first worknode deployed on the first device in FIG. 1, if the output target data out of the first worknode according to the computational subgraph assigned to itself, is the input of the second worknode deployed on the second device, the output target data out of the first worknode needs to be transmitted from the first device to the second device to allow the second worknode to obtain the input data.

Based on this, in the distributed communication system provided in the present disclosure, the first worknode is deployed on the first device, the second worknode is deployed on the second device, and the first worknode and the second worknode respectively perform the data processing task assigned to itself.

In addition, the distributed communication system further includes a first Dynamic Communication Network Object (DCNO) configured on the first device, and a second DCNO configured on the second device. In the present disclosure, the first DCNO and the second DCNO are actually global objects created respectively when the first device and the second device are running, which are used for multi-device data transmission and message communication. DCNOs may be abstract classes, defining a plurality of virtual functions used to perform at least one of the following operations: receiving input data required for performing data processing tasks by corresponding worknode in the current device; sending the target data output from the corresponding worknodes in the current device and obtained by performing the data processing task, and messages transmitted between respective worknodes; and performing collective communication operations.

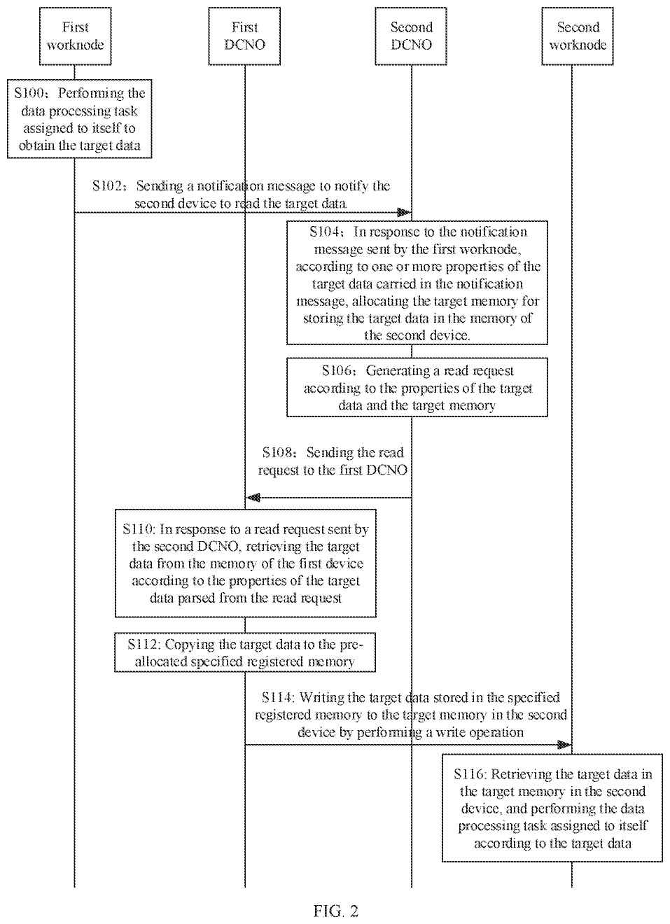

In the present disclosure, the distributed communication system is suitable for scenarios where the first device and the second device are different devices, requiring data transmission between the first device and the second device. At this time, with the support of RDMA technology, the cross-device data communication between the first worknode and the second worknode may be achieved through data transmission or message communication between the first DCNO and the second DCNO. Based on this, the present disclosure provides a distributed communication method executed based on a distributed communication system, as shown in FIG. 2, the method may include steps S100 to S116 as follows.

In step S100: The first worknode performs the data processing task assigned to itself to obtain the target data.

In the present disclosure, as mentioned earlier and shown in FIG. 1, for example, a distributed communication system is applied to the model training. The data processing task assigned to respective worknodes may be a training task of a submodel. Specifically, according to the model structure of the target model to be trained and the training samples used in training, the model training task is generated; according to the number of worknodes and the computing power resources that each of the worknodes can provide, the model training task corresponding to the target model is divided into a plurality of model training subtasks; and then, each of the model training subtasks is assigned to each of the worknodes. Thus, the model training task can be completed by asynchronously executing the assigned model training subtasks at each of the worknodes.

For example, assuming that the data processing task assigned to the first worknode is the model training task of some submodels in the image processing model, the data processing task assigned to the first worknode may include the model structure of the submodel, and the training samples needed for the model training task, such as sample images. The first worknode can input the sample images into the submodel, obtain the feature vector of the sample image output by the submodel, which is regarded as the target data obtained by the first worknode performing the data processing task assigned to itself.

The target model to be trained can be compiled into a target computational graph, which includes a plurality of operator nodes used to complete data processing operations such as convolution and pooling in neural networks. The target computational graph may be divided into a plurality of computational subgraphs, each of which includes at least one operator node. Computational subgraphs are assigned to respective worknodes for execution, so to support the training process of the target model based on the computing power resources of the respective worknodes.

But in fact, the distributed communication system and distributed communication method provided by the present disclosure are not limited to the model training scenario. According to the different data processing tasks performed by respective worknodes, the distributed communication system and distributed communication method provided by the present disclosure can also be applied in various scenarios such as distributed model reasoning, data synchronization and transmission of distributed databases, distributed energy scheduling optimization, etc. In other words, the present disclosure does not limit the specific application scenarios of distributed communication systems and distributed communication methods.

The above-mentioned target model can be any type of DL network, the target model can be used to perform image processing tasks, speech processing tasks, text processing tasks, video processing tasks and any other kind of existing data processing tasks. Accordingly, as the tasks to be processed by the target model are different, both the number of training samples for training the target model and the number of operator nodes contained in the corresponding target computational graph can also be different. In other words, the present disclosure does not limit the number of the training samples adopted by the target model and the number of operator nodes contained in the target computational graph. In addition, the present disclosure does not limit the training method of the target model (supervised learning mode, unsupervised learning mode, etc.), either. The target computational graph corresponding to the target model can be a static computational graph or a dynamic computational graph, or otherwise, some part of the target computational graph is a static computational graph, and some part of the computational graph is a dynamic computational graph. Wherein, the dynamic computational graph refers to the computational graph that is created with code execution, which can be created a plurality of times and run a plurality of times, such as Pytorch; the static computational graph refers to the computational graph that is defined and created first according to the model structure of the target model, and then runs, without changes during the run, such as TensorFlow.

In the distributed communication system shown in FIG. 1, a first worknode is deployed on the first device, a second worknode is deployed on the second device, based on the computational graph of the target model to be trained suitable for the distributed communication system, computational subgraphs can be divided from the computational graph, then allocated to the first worknode and second worknode respectively. Wherein, there may be upstream and downstream relationships between respective computational subgraphs obtained by division of the computational graph based on the target model. For example, assuming that the output data of computational subgraph A is the input data of computational subgraph B, then computational subgraph A is the upstream of computational subgraph B. Therefore, when the computational subgraph assigned to the first worknode is upstream of the computational subgraph assigned to the second worknode, it indicates that the output data obtained by the first worknode performing the data processing task based on the assigned computational subgraph, needs to be sent to the second worknode and used as the input of the second worknode. Thus, the second worknode can, using the received input, combined with the computational subgraphs assigned to the second worknode, perform the data processing task to obtain the output data.

In step S100, based on the computational subgraph assigned to itself, the first worknode can perform the data processing task and output target data. The target data can be stored in the physical memory of the first device, cache, or the pre-registered registered memory. The target data can be any type of data such as numerical vectors, feature maps, etc., and the present disclosure does not limit this. In general, in response to that the first worknode determines the target data, the target data is stored by the first device, that is, the target data occupies a certain storage space of the first device, so it corresponds to a specific storage address and data length. Wherein, the input data of the first worknode to perform a data processing task may come from another worknode, and the another worknode may belong to the first device along with the first worknode, or be deployed on other devices.

In step S102: The first worknode sends a notification message to the second DCNO, the notification message is used to notify the second device to read the target data.

In the present disclosure, the first device and the second device can be different devices, for example, the first worknode deployed on the first device performs a data processing task, and outputs the target data which is the input data required for executing a data processing task by the second worknode deployed on the second device. Therefore, it is necessary to adopt the distributed communication system and distributed communication method provided in the present disclosure to achieve cross-device communication between the first device and second device. Wherein, the data processing task performed by the first worknode and the data processing task performed by the second worknode can be the same or different. For example, the first worknode performs the model training task of the first submodel of the target model, and the second worknode performs the model training task of the second submodel of the target model, wherein the output of the first submodel is the input of the second submodel.

In the present disclosure, by adopting RDMA technology, unnecessary data copying during data transmission is eliminated, and occupying a large amount of CPU resources is effectively avoided. Therefore, both the first device and the second device are configured with a network card (also called network adaptor) that supports RDMA communication (equivalent to implementing the RDMA engine), the network adaptor creates a channel from the RDMA engine to memory with Peripheral Component Interconnect express (PCIe) bus. With this channel, the kernel can be bypassed during data transfer, so that the CPU no longer needs to participate in the data transfer or transmission process. In addition, during the communication between the first device and the second device, the network protocol that supports RDMA can be InfiniBand, RDMA over Converged Ethernet (RoCE), Internet Wide Area RDMA Protocol (iWARP).

When the first worknode in the first device obtains the target data by performing the data processing task, the target data can be temporarily stored in the memory of the first device, which is prepared for transmission. In response to that the target data is sent to the second device, the memory of the first device which the target data occupied is then released (deallocated).

In order to improve the efficiency of data transmission, after obtaining the target data, the first worknode that produces the target data can notify the second worknode, which is about to perform the data processing task based on the target data, that the target data has been determined and is ready for transmission. In contrast, if the second worknode periodically sends target data acquisition requests to the first worknode, because the target data acquisition requests also occupies communication bandwidth and computing resources of the second device, it leads to resource waste and reduces communication efficiency. If the first worknode delays in determining the target data, the second worknode can also frequently send target data acquisition requests to the first worknode, further causing resource waste and reducing communication efficiency. For this reason, the present disclosure adopts the method of sending notification messages to the second worknode in response to that the first worknode determines the target data, without the need for the second worknode to frequently send target data acquisition requests.

In step S104: In response to the notification message sent by the first worknode, according to one or more properties of the target data carried in the notification message, the second DCNO allocates the target memory for storing the target data in the memory of the second device.

In practical use, there may be upstream and downstream relationships between the data processing tasks assigned to respective worknodes. For example, the data processing task assigned to the first worknode is the upstream of the data processing task assigned to the second worknode. That is, the target data output by the first worknode executing the data processing task is the input of the data processing task executed by the second worknode. In order to achieve the effect that the first worknode notifies the second worknode to obtain target data from the first device, the notification message sent by the first worknode carries at least the properties of the target data. Wherein, the properties of the target data include the storage address of the target data, the length of the target data, the data type of the target data, etc.

Based on this, when the second DCNO receives a notification message sent by the first worknode, the target data can be obtained from its storage address based on the properties of the target data carried in the notification message. In addition, in order to enable the second worknode in the second device to execute the data processing task with the target data as input, usually a certain length of target memory can be registered in the second device to temporarily store the target data, and the target memory can be deallocated after the second worknode completes the data processing task based on the target data.

In some embodiments, the second DCNO determines the target length of the target memory according to the length of the target data carried in the notification message, the target length is not less than the length of the target data, and allocates, in the memory of the second device, the target memory of the target length to store the target data.

In general, RDMA operations begin with operating the memory of the device. Registering the target memory in the second device is equivalent to identifying that the target memory is dedicated to storing target data, and the network adaptor configured on the second device can perform addressing on this target memory and establish a channel from the network adaptor of the second device to the target memory. When registering, you can set the read and write permissions (including remote read and write and local read/write) on the target memory, which can be read and write through local key or remote key. The key used for read and write permissions can be obtained during memory registration. Wherein, the local key is used for a local network adaptor to access the local memory. The remote key is provided to a network adaptor of a remote device to access the memory of the local device. In response to that the target memory is registered, RDMA operations can be performed on the target memory. In the present disclosure, the first DCNO may perform RDMA write operations on the target memory, so to transfer the target data stored in the first device to the target memory in the second device without performing data copying and without CPU participation.

In step S106: The second DCNO generates a read request according to the properties of the target data and the target memory.

The properties of the target data may include the storage address of the target data in the first device and the length of the target data, and the target memory information may include the address of the target memory and the length of the target memory for storing data. Based on the properties of the target data and the target memory, a read request is generated, and the read request is used to read the target data from the first device and write it to the target memory in the second device. In addition, in order to enable the first DCNO in the first device to have a write permission to perform a write operation on the target memory in the second device, the write permission obtained by registering the target memory in the second device can also be put in a read request to be sent to the first DCNO in the first device.

In step S108: The second DCNO sends the read request to the first DCNO.

In step S110: The first DCNO retrieves the target data from the memory of the first device in response to the read request, according to the properties of the target data parsed from the read request.

Because the read request carries the properties of the target data, and the properties of the target data may include the storage address of the target data and the length of the target data, based on the properties of the target data, the first DCNO can retrieve the target data with the full length from the first device.

In step S112: The first DCNO copies the target data to the pre-allocated specified registered memory.

Wherein, the pre-allocated specified registered memory is used to store data to be written to other devices. Thus, if in the first device, there are a plurality sets of target data to be written to different devices, the write operations of respective sets of target data can be performed asynchronously, so to improve the efficiency of data transmission.

For example, for the target data data₁ and target data data₂ stored in the first device, target data data₁ needs to be written to device A, target data data₂ needs to be written to device B, the first device, when retrieving the target data data₁ and data₂ based on the read request sent by devices A and B respectively, respectively puts the target data data₁ and data₂ into the specified registered memory. Therefore, the first device does not need to perform the operation of writing the target data data₂ to device B in response to that the operation of writing the target data data₁ to device A is completed, instead, during the process of writing the target data data₁ to device A, the first device can start the operation of writing the target data data₂ to device B.

In step S114: The first DCNO writes the target data stored in the specified registered memory to the target memory in the second device by performing a write operation.

As mentioned above, the first DCNO, when receiving the read request sent by the second DCNO, obtains the permission to perform write operations on the target memory, which is equivalent to that the second DCNO gives the operation permission on the target memory to the first DCNO. At the same time, the read request also carries the address and length of the target memory, the first DCNO can write the target data to the target memory with the established channel in step S102, based on the method of write operation. Whether the first DCNO directly writes the complete target data to the target memory, or writes the target data segmentally to the target memory, the present disclosure does not limit this.

In step S116: The second worknode retrieves the target data from the target memory in the second device, and performs the data processing task assigned to itself according to the target data.

Because the target data obtained by the first worknode performing the data processing task is the input of the second worknode to perform the data processing task, after the first DCNO writes the target data to the target memory in the second device, the second worknode can directly obtain the target data from the target memory in the second device, thereby performing the data processing task assigned to the second worknode according to the target data.

Afterwards, if the data obtained by the second worknode performing the data processing task based on the target data is input data for a data processing task to be performed by one or more worknodes deployed on one or more other devices, the original second device can be used as a new first device, and the other device can be used as a new second device, then go back and repeat step S100 until all worknodes have completed the data processing tasks.

In the distributed communication method provided according to the embodiment of the present disclosure, direct communication across devices is achieved through the interaction between the first dynamic network object configured on the first device and the second dynamic network object configured on the second device. Thus, there is no need for a great deal of unnecessary data copy or occupying CPU resources, thereby effectively improving communication efficiency and scaling up data parallelism.

Also, when the distributed communication system and communication methods are applied to the model training process, the distributed communication system can also include a parameter server, the parameter server is used to maintain the model parameters of the submodels assigned to respective worknodes. In addition, the parameter exchange between the parameter server and respective worknodes deployed on each device can also adopt a distributed communication solution similar to the previous solution in FIG. 2.

In one or more embodiments of the present disclosure, as shown in step S114 of FIG. 2, the first DCNO, in response to that the target data is completely written to the target memory, needs to notify the second DCNO that the operation of writing the target data has been completed. Thus, the second worknode knows that it can perform a data processing task based on the target data. For this purpose, the write operation of the first DCNO to write target data to the target memory can be a write operation with specified information. Wherein, the specified information is used to notify the second DCNO that data has been written to the target memory.

For the case where the complete target data is directly written to the target memory: the first DCNO generates specified information, the specified information is used to notify the second DCNO that the target data has been written to the target memory in the second device; so, the first DCNO writes the target data in the specified registered memory to the target memory in the second device by performing a write operation, and writes the specified information to a completion queue (CQ) in the second device. Wherein, the CQ is pre-created in the second device, and the CQ is used to store completed work requests (WR). Therefore, the second DCNO determines whether the target data has been written to the target memory in the second device by querying the CQ in the second device, according to the specified information contained in the CQ. If the CQ contains complete specified information, determining that the target data has been completely written to the target memory; if the specified information does not exist in the CQ or is incomplete, it indicates that the target data has not been completely written to the target memory.

For the case of writing the target data to the target memory in a segmental manner: the first DCNO divides the target data according to a preset data length to obtain multiple subdata segments; for each of the subdata segments, generates specified information corresponding to the subdata segment, and the specified information is used to notify the second DCNO that the subdata segment has been written to the target memory in the second device; so then, the first DCNO writes each of the subdata segments from the target data stored in the specified registered memory to the target memory in the second device in a sequence by performing write operations; and writes, in an order of the sequence for writing the subdata segments, the specified information corresponding to each of the subdata segments to the CQ in the second device. Therefore, the second DCNO, by querying the CQ in the second device, and according to the specified information contained in the CQ, can determine whether each of the subdata segments been written to the target memory in the second device. If the CQ contains complete specified information, determining that the target data has been completely written to the target memory; if the specified information does not exist in the CQ or is incomplete, it indicates that the target data has not been completely written to the target memory.

In addition, as shown in FIG. 2, when the solution writes the target data to the target memory in a segmental manner, no matter how long the length of the target data is, each of the subdata segments can be written to the target memory one by one by writing in segments. It can be seen that the distributed communication solution provided according to the embodiments of the present disclosure supports dynamic network communication of variable-length data, and can adapt to different neural network models and data types, thereby effectively expanding the application scenarios of distributed communication systems and methods.

In both of the above cases, it is necessary that a CQ is pre-created in the second device, which is used to store completed WR. The WR stored in the CQ only states that the WR (send, receive, read, write) has been completed, but does not indicate the execution result of the WR. In other words, regardless of whether the execution result of the WR is successful or unsuccessful, as long as the WR has been completed, the corresponding element will be written in the CQ.

In addition, by storing the specified information in the CQ, because the specified information is not be copied to the memory of the second device, so the memory of the second device is not occupied; and the second worknode only needs to check the CQ to know whether the target data has been written, without accessing the memory, nor repeatedly performing unnecessary copy operation, thereby improving the efficiency of data transmission.

Correspondingly, a polling thread can be created in the second device, which is specifically used to poll the CQ, check whether the CQ has received the completed WR, and obtain the relevant information of the completed WR such as the completion status, size, source address, etc. The polling thread can also be used to check the CQ for a WR with an error completion status and send an error message to the source address of the WR that has an error completion status so that the WR can be modified and re-executed. In general, the CQ has a one-to-one correspondence with the polling thread, that is, each polling thread can only poll one CQ.

In addition, a CQ can record the completion status of various types of WR (send, receive, read, write), and invoke the corresponding callback method in response to a reception of the completion event. The advantage of doing this is that the main thread is not blocked and can handle a plurality of queues and a plurality of WR. The CQ can be initialized by invoking an interface of creating a CQ. When the CQ is no longer necessary to record the completion status of the WR, the CQ can be destroyed by invoking an interface of destroying a CQ.

The above solutions all use the first DCNO in the first device to write the target data stored in the first device to the target memory in the second device by performing a write operation, which is equivalent to a RDMA-based unilateral write operation. Wherein, the second DCNO only needs to provide the address of the target memory that needs to be written to the first DCNO, without the need to participate in the data transmission process. In fact, the second worknode only needs to retrieve the target data from the target memory when requiring the target data to perform the data processing task, without knowing the beginning and end of transmission process for the target data.

In practical use, the target data transmission between the first device and the second device can also be completed with the unilateral read operation of RDMA. Since in step S104 the second DCNO has obtained the properties of the target data parsed from the notification message, the only difference between the solution of a unilateral read operation and the solution shown in FIG. 2 is that before the second DCNO generates a read request in step S106, the first DCNO needs to give the permission to read the target data to the second DCNO. Thus, in step S108, when the second DCNO sends a read request to the first DCNO, it has the permission to directly perform a read operation on the target data stored in the first device, thereby transmitting the target data to the second device.

When the second DCNO determines that the target data has been written to the target memory in the second device according to the specified information stored in the CQ, the second DCNO generates an acknowledgment (ACK) message, and sends the ACK message to the first DCNO. Wherein the confirmation message is configured to notify the first DCNO to deallocate the memory occupied by the target data in the first device. Next, the first DCNO, in response to the ACK message sent by the second DCNO, deallocates the memory occupied by the target data in the first device. The deallocated memory can then be reused to store other data, such as the next target data that needs to be transmitted. Thus, the memory used to store the target data in the first device can be deallocated in time to avoid a large amount of memory being occupied for no reason, thereby improving the utilization rate of memory resources.

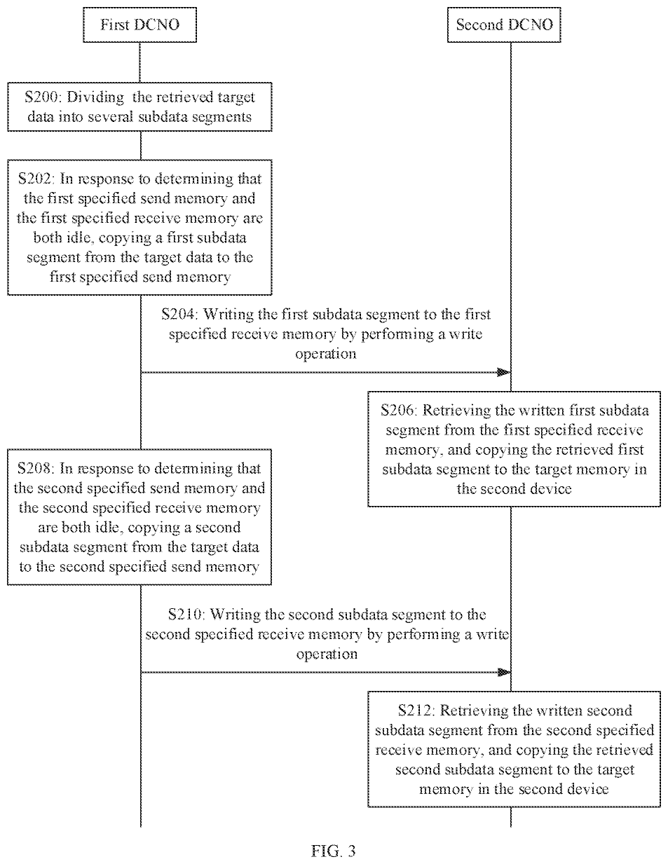

For the processing of writing the target data to the second device through steps S104 to S114 as shown in FIG. 2, in one or more embodiments of the present disclosure, the target data may also be transmitted from the specified send memory of the first device to the specified receive memory of the second device based on a send queue (SQ) and a receive queue (RQ). For example, in the memory of the first device, a first specified send memory and a second specified send memory can be pre-allocated to store data to be sent; in the memory of the second device, a first specified receive memory and a second specified receive memory can be pre-allocated to store data to be received; there is a correspondence between the first specified send memory and the first specified receive memory, and there is a correspondence between the second specified send memory and the second specified receive memory. As shown in FIG. 3, the specific solution may include the following steps S200 to S200.

In step S200: the first DCNO divides the retrieved target data into multiple subdata segments.

In order to further improve the efficiency of data transmission, it is possible to increase the parallelism degree of data transmission. To do so, in the first device, a first specified send memory and a second specified send memory can be registered to store data in the state of being sent (such as the target data in the first device). Correspondingly, in the second device, a first specified receive memory and a second specified receive memory can be registered to store received data. Besides, in response to that the first specified send memory and the second specified send memory are allocated (registered), the first device can learn from the second device whether the first specified receive memory and the second specified receive memory are allocated in the second device; if the first specified receive memory and the second specified receive memory are allocated, the correspondence between the first specified send memory and the first specified receive memory can be established, and the correspondence between the second specified send memory and the second specified receive memory can be established. In this regard, the first specified send memory and the first specified receive memory can be used in pairs, and the second specified send memory and the second specified receive memory can be used in pairs.

Since a first specified send memory and a second specified send memory are allocated in the first device, the target data can be divided into multiple subdata segments, and each of the subdata segments is stored in the first specified send memory and the second specified send memory, and then the subdata segments are sent from the first specified send memory and the second specified send memory to the second device respectively, to achieve the complete transmission of the target data. In this step, the target data is divided into multiple subdata segments, and the length of each of the subdata segments can be the same or different, and the present disclosure does not limit the length and number of the subdata segments.

The present disclosure only takes two pairs of specified send memory and specified receive memory that are used in pairs, as an example, to illustrate the solution for improving the parallelism of data transmission. In practical use, it is also possible to allocate a plurality pairs of specified send memory and specified receive memory. For example, if allocating four specified send memory on the first device and four specified receive memory on the second device, then totally there are four pairs of specified send memory and specified receive memory, so the target data can be divided into four subdata segments and placed into four specified send memory respectively, then based on the four specified send memory, data transmission can be performed asynchronously.

In step S202: In response to determining that the first specified send memory and the first specified receive memory are both idle, the first DCNO copies a first subdata segment from the target data to the first specified send memory.

Generally, the first specified send memory and the first specified receive memory are used in pairs, that is, the data copied to the first specified send memory is only to be transferred to the first specified receive memory, therefore, the first subdata segment copied to the first specified send memory is to be written to the first specified receive memory by the first DCNO. When the first specified send memory and the first specified receive memory are subjected to data transmission, data is stored in the first specified send memory and/or the first specified receive memory, at this time, the first specified send memory and the first specified receive memory are in the state of being occupied. Therefore, the transmission the first subdata segment can only be executed when it is determined that both the first specified send memory and the first specified receive memory are in the state of being idle (no stored data).

In addition, the first specified send memory and the first specified receive memory can be managed by a first queue pair (QP) in the first device. Wherein, the first QP contains the first send queue (SQ) and the first receive queue (RQ), the first SQ is used to hold the send requests, and the first RQ is used to hold the receive requests. Correspondingly, the second specified send memory and the second specified receive memory can be managed by a second queue pair (QP) in the second device

The first DCNO can also manage the CQ in the first device, the CQ is used to store relevant information about WR, such as the status of request completion, operation code, size, source address, etc. The first DCNO manages the completion events of the first QP, the completion events recorded in the first SQ and the first RQ in the first QP are both sent to the CQ, and then the CQ is polled on the first device to determine which requests are completed. The same method also applies to the second DCNO.

In step S204: The first DCNO writes the first subdata segment to the first specified receive memory by performing a write operation.

This step is similar to step S114 shown in FIG. 2 and will not be repeated here.

In step S206: The second DCNO retrieves the written first subdata segment from the first specified receive memory, and copies the retrieved first subdata segment to the target memory in the second device.

Since the second worknode retrieves target data from the target memory, after writing the first subdata segment to the first specified receive memory, the second DCNO needs to copy the first subdata segment to the target memory in the second device, in order for the second worknode to retrieve target data from the target memory.

In step S208: In response to determining that the second specified send memory and the second specified receive memory are both idle, the first DCNO copies a second subdata segment from the target data to the second specified send memory.

Similar to step S202 mentioned earlier, the second specified send memory and the second specified receive memory, between which there is a correspondence, are used in pairs. That is, the data in the second specified send memory is only to be transferred to the second specified receive memory.

After the first DCNO writes the first subdata segment from the first specified send memory to the first specified receive memory by performing a write operation, the second subdata segment, next to the subdata segment and from the target data, can be transmitted with the second specified send memory and the second specified receive memory, to complete the data transmission. That is, at least step S208 is performed after step S204.

In the case that the first specified send memory and the second specified send memory are two independent memory spaces, and the first specified receive memory and the second specified receive memory are two independent memory spaces too, at the same time as transferring the first subdata segment from the first specified send memory to the first specified receive memory, the second subdata segment can also be transferred from the second specified send memory to the second specified receive memory. That is, while performing steps S204 to S206, perform steps S208 to S210.

In step S210: The first DCNO writes the second subdata segment to the second specified receive memory by performing a write operation.

This step is similar to step S114 shown in FIG. 2 and will not be repeated here.

In step S212: The second DCNO retrieves the written second subdata segment from the second specified receive memory, and copies the retrieved second subdata segment to the target memory in the second device.

Before step S202, it is also necessary to determine the presence of the first specified receive memory in the second device corresponding to the first specified send memory, and to determine the presence of the second specified receive memory in the second device corresponding to the second specified send memory. Thus, in an optional embodiment of the present disclosure, the first DCNO is further configured to obtain, by invoking a remote procedure call in advance, information of the first specified receive memory and the second specified receive memory allocated in the second device to which the second DCNO belongs.

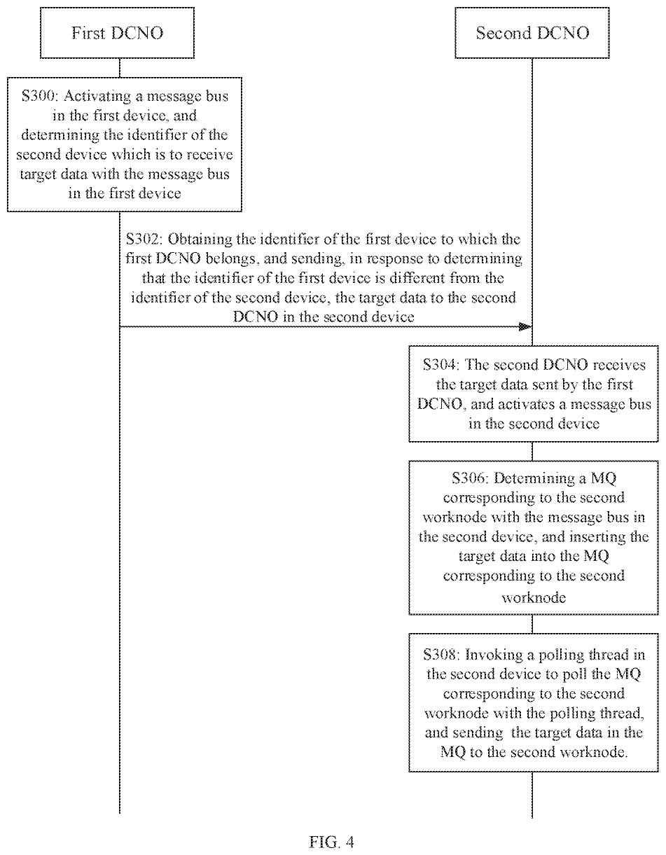

For the processing of writing the target data to the second device by step S104 to S114 as shown in FIG. 2, in one or more embodiments of the present disclosure, the transmission of the target data may also be achieved based on the message bus in the first device and the message bus in the second device. As shown in FIG. 4, the specific solutions may include the following steps S300 to S308.

In step S300: The first DCNO activates a message bus in the first device, and determines the identifier of the second device which is to receive target data with the message bus in the first device.

In the process of data transmission between the first device and second devices with RDMA technology, in addition that the first DCNO writes the target data to the target memory in the second device by performing a write operation as described above, the first device can also actively send the target data to the second device, and with the message bus of the second device, the target data is transmitted to the second worknode to perform a data processing task.

To do this, the message bus in the first device can be activated first; then the message bus in the first device can determine, according to the downstream task of the data processing task performed by the first worknode in the first device, which other working nodes the target data obtained by the first worknode can be sent to. Generally, when the first worknode receives the data processing task assigned to the first worknode, it can also send the identifier of the downstream task of the data processing task to the first worknode, the message bus can then determine the worknodes executing downstream tasks among the respective worknodes based on the identifier of this downstream task, and then determine the devices to which the worknodes executing downstream tasks belong.

The devices to which respective worknodes belong have a unique identifier to identify which device the respective worknodes are deployed on. The identifier of the device can be any existing string, and the type and length of the identifier are not limited in the present disclosure.

In step S302: The first DCNO obtains the identifier of the first device to which the first DCNO belongs, and sends, in response to determining that an identifier of the first device to which the first DCNO belongs is different from the identifier of the second device, the target data to the second DCNO in the second device.

Generally, devices with the same identifier are the same device, while devices with different identifier are two different devices.

When the device to which the worknode executing downstream tasks belongs (the second device) is the same device as the first device, transmitting the target data to the worknode executing downstream tasks does not belong to the cross-device data transmission process. In this case, by retrieving the message queue (MQ) corresponding to the worknode executing downstream tasks with the message bus of the first device, and pushing the target data into the message queue, the purpose that the worknode executing downstream tasks obtains the target data can be achieved.

When the second device and the first device are not the same device, the data transmission process of transmitting target data to the second worknode deployed on the second device is a cross-device data transmission process. In this case, the interaction between the first DCNO and the second DCNO is required to achieve the transmission of the target data from the first device to the second device.

Specifically, the first DCNO can package the target data according to the communication protocol and algorithm followed by the first device and second device, and send it to the second DCNO configured on the second device with a specified interface. This specified interface is similar to the channel described in step S102, which is the message transmission interface between the network adaptor that supports RDMA communication in the first device and network adaptor that supports RDMA communication in the second device. The data or messages transmitted with this specified interface can bypass the kernel, no longer requiring CPU participation in data transmission or transferring.

In step S304: The second DCNO receives the target data sent by the first DCNO, and activates a message bus in the second device.

In step S306: The second DCNO determines a MQ corresponding to the second worknode with the message bus in the second device, and inserts the target data into the MQ corresponding to the second worknode.

Specifically, the target data sent by the first DCNO can also carry the identifier corresponding to the second worknode, and the message bus of the second device can determine the second worknode to which the target data is transmitted by parsing the target data, and therefore, retrieve the thread that performs the data processing task of the second worknode and the MQ corresponding to the thread, that is, the MQ corresponding to the second worknode.

In step S308: The second DCNO invokes a polling thread in the second device to poll the MQ corresponding to the second worknode with the polling thread, and sends the target data in the MQ to the second worknode.

In this step, a pre-created polling thread in the second device is invoked to poll the MQ corresponding to the second worknode. When there is target data in the MQ corresponding to the second worknode, the target data is sent to the second worknode, thereby enabling the second worknode to perform a data processing task based on the target data.

A solution in which the second worknode actively queries the MQ may also be adopted. However, compared with the solution of polling the MQ with a polling thread, the second worknode actively querying the MQ occupies the computing resources of the second worknode, and frequently querying the MQ occupies a large amount of computing resources, thereby reducing the computing resources used to perform data processing tasks. Therefore, the solution of polling thread detecting MQ is recommended, as long as there is data in the MQ, the data is sent to the second worknode without the need that the second worknode frequently queries the MQ. This maximizes the available computing resources of the second worknode for executing data processing tasks, rather than wasting them on querying the MQ, thereby effectively improving the efficiency of data processing.

In the present disclosure, the first DCNO in the first device and the second DCNO in the second device are actually global objects created during the run of the first device and the second devices, used as modules for cross-device data transmission and message communication. The defined dynamic communication network structure is an abstract class, which defines some virtual function, used to send and receive target data and other messages output by the data processing task executed by the worknode, as well as perform collective communication operations. Different communication protocols and algorithms will inherit the dynamic communication network abstract class and implement these virtual functions.

Wherein, virtual functions may include methods for sending worknode messages, methods for receiving worknode messages, and so on. The method of sending worknode messages is used to send a structure of worknode messages, the structure contains the identifier of the worknode and the task information, which is used to indicate the information of the data processing task assigned to the worknode. The method of receiving work node messages is used to receive a structure of worknode messages, which returns the identifier of device being as the sender and a worknode message pointer, and they are used to indicate which device has received what kind of message.

In the process that the first device and the second device create the global objects of dynamic communication network, the communication protocol and algorithm adopted by the first device and the second device can be determined according to the dynamic communication network environment variable, and the factory method matching the communication protocol and algorithm can be invoked to create the first DCNO in the first device and create the second DCNO in the second device. Wherein, creating DCNO s can be implemented in the following steps.

Step 1: In the factory method, creating and returning a smart pointer of the DCNO, and assign it to the global object of dynamic communication network.

Step 2: In the method of constructing a DCNO, a worker object of the dynamic communication network implementation class is created, and then the construction and initialization methods therein can be invoked.

Step 3: In the construction method of the worker object of the dynamic communication network implementation class, a resource related to the dynamic communication network implementation class is created, and a polling thread is started to handle the events of the dynamic communication network implementation class.

Step 4: In the initialization method of the worker object in the dynamic communication network implementation class, a corresponding number of communication objects is created based on the number of machines and addresses in the cluster, and then the construction and initialization methods therein can be invoked.

Step 5: In the construction method of the communication object, a buffer pool object is created to manage the application and release of the buffer.

Step 6: In the initialization method of the communication object, a dynamic communication network connection is established based on the address of the target machine, and registered in the event of the dynamic communication network implementation class.

FIG. 5 is a diagram of a distributed communication apparatus provided in the present disclosure, which is applied to a first device and configured as a first DCNO, further including a target data determination module 400, a copy module 402, and a first write module 404.

Wherein, the target data determination module 400 is configured to, in response to a read request sent by a second DCNO configured on a second device, according to one or more properties of target data parsed from the read request, retrieve the target data from memory of the first device. Wherein the read request is generated by the second DCNO in response to a notification message sent by a first worknode deployed on the first device, according to the properties of target data carried in the notification message and target memory allocated for the target data.

The copy module 402 is configured to copy the target data to a pre-allocated specified registered memory.

The first write module 404 is configured to write the target data stored in the specified registered memory to target memory in the second device by performing a write operation, so that a second worknode deployed on the second device retrieves the target data from the target memory, and according to the retrieved target data performs a data processing task assigned to the second worknode itself.

In some embodiments, a CQ is pre-created in the second device, and the CQ is used to store completed WR. Accordingly, the first write module 404 can be further configured to: divide the target data according to a preset data length to obtain multiple subdata segments; for each of the subdata segments, generate specified information corresponding to the subdata segment, and the specified information is used to notify the second DCNO that the subdata segment has been written to the target memory in the second device; write each of the subdata segments from the target data stored in the specified registered memory to the target memory in the second device in a sequence by performing a write operation; and write, in an order of the sequence for writing the subdata segments, the specified information corresponding to each of the subdata segments to the CQ in the second device; so that the second DCNO determines whether each of the subdata segments from the target data has been written to the target memory in the second device by querying the specified information contained in the CQ in the second device.

In some embodiments, a first specified send memory and a second specified send memory are pre-allocated in the memory of the first device, a first specified receive memory and a second specified receive memory are pre-allocated in the memory of the second device, wherein, there is a correspondence between the first specified send memory and the first specified receive memory, there is a correspondence between the second specified send memory and the second specified receive memory. Accordingly, the apparatus can also include a second write module 406, which is further configured to: divide the target data into multiple subdata segments; copy, in response to determining that the first specified send memory and the first specified receive memory are both idle, a first subdata segment from the target data to the first specified send memory, and further write the first subdata segment to the first specified receive memory by performing a write operation, so that the second DCNO retrieves the first subdata segment from the first specified receive memory, and copies the retrieved first subdata segment to the target memory in the second device; copy, in response to determining that the second specified send memory and the second specified receive memory are both idle, a second subdata segment from the target data to the second specified send memory, and further write the second subdata segment to the second specified receive memory by performing a write operation, so that the second DCNO retrieves the second subdata segment from the second specified receive memory, and copies the retrieved second subdata segment to the target memory in the second device.

In some embodiments, the apparatus can also include a transmitting module 408, which is further configured to: activate a message bus in the first device, and determine an identifier of the second device to receive the target data with the message bus in the first device; send, in response to determining that an identifier of the first device to which the first DCNO belongs is different from the identifier of the second device, the target data to the second DCNO in the second device. Thus, the second DCNO can: receive the target data sent by the first DCNO; activate a message bus in the second device; determines a MQ corresponding to the second worknode with the message bus in the second device; insert the target data into the MQ corresponding to the second worknode; and send, by polling the MQ corresponding to the second worknode with a polling thread invoked in the second device, the target data in the MQ to the second worknode.

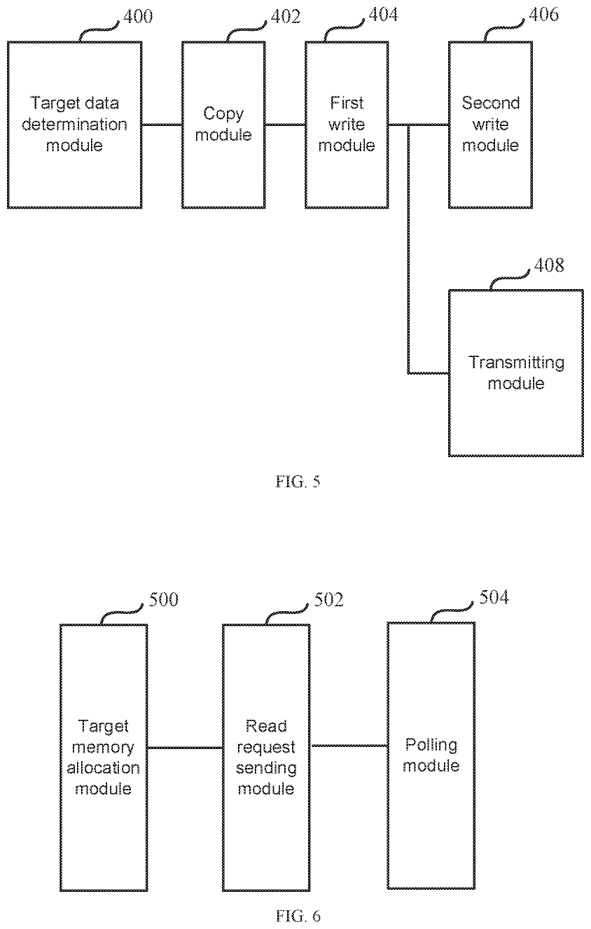

FIG. 6 is a diagram of a distributed communication apparatus provided in the present disclosure, which is applied to a second device and configured as a second DCNO, further including a target memory allocation module 500 and a read request sending module 502.

Wherein, the target memory allocation module 500 is configured to: in response to the notification message sent by a first worknode deployed on a first device, according to one or more properties of the target data carried in the notification message, allocate target memory for storing the target data in the memory of the second device. Wherein, the target data is obtained by the first worknode performing a data processing task assigned to itself, the notification message is generated according to the target data and sent by the first worknode.

The read request sending module 502 is configured to: generate a read request according to the properties of the target data and the target memory, and send the read request to a first DCNO configured on the first device. Thus, the first DCNO can: retrieve the target data from memory of the first device according to the properties of target data parsed from the read request, copy the target data to the pre-allocated specified registered memory, and write the target data stored in the specified registered memory to the target memory in the second device by performing a write operation, so that a second worknode deployed on the second device performs the data processing task assigned to itself based on the target data in the target memory.

In some embodiments, the target memory allocation module 500 is further configured to: determine target length of the target memory according to the length of the target data carried in the notification message, and the target length is not less than the length of the target data; allocate, in the memory of the second device, the target memory of the target length.

In some embodiments, the apparatus can also include a polling module 504, which is further configured to: receive the target data sent by the first DCNO; activate a message bus in the second device; determine a MQ corresponding to the second worknode with the message bus in the second device; insert the target data into the MQ corresponding to the second worknode; send, by polling the MQ corresponding to the second worknode with a polling thread invoked in the second device, the target data in the MQ to the second worknode, so that the second worknode performs the data processing task assigned to itself based on the target data in the target memory.

The present disclosure also provides a computer-readable storage medium that stores computer programs, which can be used to execute the above-mentioned distributed communication method.

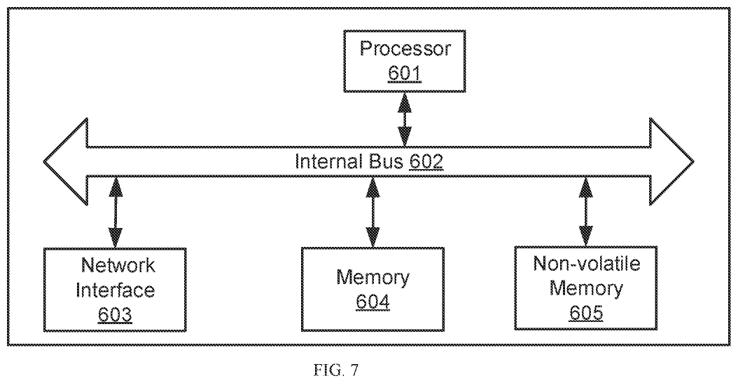

The present disclosure also provides a structure diagram of an electronic device as shown in FIG. 7. As shown in FIG. 7, at the hardware level, the electronic device includes a processor 601, an internal bus 602, a network interface 603, a memory 604, and a non-volatile memory 605, and can include other hardware required by services. The processor 601 reads the corresponding computer program from non-volatile memory 605 into memory 604 and runs it to achieve the distributed communication method. Of course, apart from software implementation methods, the present disclosure does not exclude other implementation methods, such as logical devices or combinations of software and hardware, etc., this means that the execution subject of the following processing flow is not limited to each logical unit, but also can be hardware or logical devices.

In the 1990s, for a technological improvement, there was a clear distinction between an improvement in hardware (for example, for the circuit structure of diodes, transistors, switches, etc.) and an improvement in software (for methods and processes). However, with the development of technology, the improvement of many methods and processes can be regarded as a direct improvement of the structure of a hardware circuit. Designers almost always obtain the corresponding hardware circuit structure by programming the improved method or process into a hardware circuit. Therefore, it is possible that an improvement of a method or a process is realized by entity modules of hardware. For example, a Programmable Logic Device (PLD) (for example, a Field Programmable Gate Array (FPGA)), is such an integrated circuit whose logic function is determined by the user programming the device. A digital system is “integrated” on a PLD through the programming of the designers, rather than a dedicated integrated circuit chip designed and produced by a chip manufacturer. Moreover, nowadays, instead of making integrated circuit chips manually, this programming is mostly implemented using “logic compiler” software, which is similar to the software compiler used in program development, and the original code before compilation must be written in a specific programming language, which is called a Hardware Description Language (HDL), there are a plurality of HDLs rather than one, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc., and the most commonly used currently are VHDL (Very-High-Speed Integrated Circuit Hardware Description Language) and Verilog. A person of ordinary skill in the art should also understand that by logically programming the method or process using the above-mentioned multiple hardware description languages and integrated it into an integrated circuit, a hardware circuit that implements such logic method or process can be easily obtained.

The controller can be implemented in any suitable manner. For example, the controller can take the form of a microprocessor or processor and a computer-readable medium, logic gates, switches, disclosure specific integrated circuits (ASICs), programmable logic controllers, and embedded microcontrollers storing computer-readable program code (such as software or firmware) executable by the (micro) processor. Examples of the controller include, but are not limited to, the following microcontrollers: ARC 625D, Atmel AT91SAM, Microchip PIC18F26K20 and Silicone Labs C8051F320. The memory controller can also be implemented as part of the control logic for the memory. A person of ordinary skill in the art also know that, in addition to implementing the controller in pure computer-readable program codes, it is entirely possible to make the controller logic gates, switches, dedicated integrated circuits, programmable logic controllers, embedded microcontrollers and the like to achieve the same function by logically programming the method and the steps. Therefore, such a controller can be regarded as a hardware component, and apparatuses included in the controller for implementing various functions can also be regarded as structures within the hardware component. Or even, devices for implementing various functions can be regarded as both software modules implementing the method and structures within hardware component.

The system, apparatus, module, or unit described in the previous embodiments may be implemented by a computer chip or entity, or may be implemented by using a product with a certain function. A typical implementation device is a computer. The computer may be a personal computer, a laptop computer, a cellular phone, a camera phone, a smartphone, a personal digital assistant, a media player, a navigation device, an email device, a game console, a tablet computer, a wearable device, or any combination of these devices.

For convenience of description, when describing the above apparatus, the functions are divided into various units for description. Of course, when implementing the present disclosure, the functions of the units may be implemented in one same or more different software and/or hardware.

Those skilled in the art should understand that the examples of the present disclosure may be implemented as a method, a system, or a computer program product. Therefore, the present disclosure may take the form of an entirely hardware implementation, an entirely software implementation, or an implementation combining both software and hardware aspects. Moreover, the present disclosure may take the form of a computer program product implemented on one or more computer-usable storage media (including, but not limited to, disk memory, CD-ROM, optical memory, etc.) containing computer-usable program code.

The present disclosure is described with reference to flowcharts and/or block diagrams of methods, devices (systems), and computer program products according to implementations of the present disclosure. It should be understood that each process and/or block in the flowcharts and/or block diagrams, and combinations of processes and/or blocks in the flowcharts and/or block diagrams may be implemented by computer program instructions. These computer program instructions may be provided to a processor of a general-purpose computer, a special purpose computer, an embedded processor or other programmable data processing device to generate a machine, such that the instructions executed by the processor of a computer or other programmable data processing device produce a device for achieving the functions specified in a flow chart or processes or processes and/or block diagram of one box or more boxes.

These computer program instructions may also be stored in computer-readable memory capable of booting a computer or other programmable data processing device to work in a particular manner, such that the instructions stored in the computer-readable memory produce manufactured products comprising an instruction device, the instruction device implements the function specified in a flow chart one or more processes and/or block diagram one box or more boxes.

These computer program instructions may also be loaded into a computer or other programmable data processing device, such that a series of operational steps are performed on a computer or other programmable device to produce computer-implemented processing, so that the instructions executed on a computer or other programmable device provide steps for achieving the functions specified in a flowchart one or more processes and/or block diagram one box or more boxes.

In a typical configuration, a computing device includes one or more processors (CPUs), an input/output interface, a network interface, and a memory.

The memory may include a transitory memory, a random access memory (RAM), and/or a non-volatile memory in a computer-readable medium, such as a read-only memory (ROM) or a flash RAM. Memory is an example of the computer readable medium.

Computer-readable media includes permanent and non-persistent, removable and non-removable media. Information storage may be accomplished by any method or technology. The information may be computer readable instructions, data structures, modules of programs, or other data. Examples of computer storage medium include, but not limited to, a phase change memory (PRAM), a static random access memory (SRAM), a dynamic random access memory (DRAM), other types of random access memory (RAM), a read only memory (ROM), an electrically erasable programmable read only memory (EEPROM), a flash memory or other memory technologies, a compact disk read only memory (CD-ROM), a digital versatile disk (DVD) or other optical storage, a cassette tape, a disk tape storage or other magnetic storage devices or any other non-transportable medium, which may be used to store information that may be accessed by a computing device. As defined herein, computer-readable media does not include temporary computer-readable media (transitory media), such as modulated data signals and carrier waves.

It should also be noted that the terms “including”, “comprising” or any other variation are intended to cover non-exclusive inclusion, so that a process, a method, a product or a device that includes a series of elements includes not only those elements, but also includes other elements that are not explicitly listed, or elements that are inherent to such process, method, product, or device. Without more restrictions, the elements defined by the sentence “including (comprising) a/an . . . ” do not exclude the existence of other identical elements in the process, method, article or apparatus that include the elements.

Those skilled in the art should understand that the examples of the present disclosure may be implemented as a method, a system, or a computer program product. Therefore, the present disclosure may take the form of an entirely hardware implementation, an entirely software implementation, or an implementation combining both software and hardware aspects. Moreover, the present disclosure may take the form of a computer program product implemented on one or more computer-usable storage media (including, but not limited to, disk memory, CD-ROM, optical memory, etc.) containing computer-usable program code.

This disclosure may be described in the general context of computer-executable instructions executed by a computer, such as program modules. Generally, program modules include routines, programs, objects, components, data structures, etc. that perform specific tasks or implement specific abstract data types. The present disclosure may also be practiced in distributed computing environments in which tasks are performed by remote processing devices connected through a communication network. In a distributed computing environment, program modules may be located in local and remote computer storage media, including storage devices.

Each embodiment in the present disclosure is described in a progressive manner, and the same or similar parts between the various embodiments may be referred to each other. Each embodiment focuses on the differences from other embodiments. In particular, with respect to the system implementations, since they are basically similar to the method implementations, the description thereof is relatively simple. For the related parts, reference may be made to the description of the method implementations.

The above are only implementations of the present disclosure and are not intended to limit the present disclosure. For those skilled in the art, this disclosure may have various modifications and changes. Any modification, equivalent replacement, and improvement made within the spirit and principle of this disclosure shall be included in the scope of claims of this disclosure.

1. A distributed communication system, comprising:
a first computing power resource deployed on a first device,
a second computing power resource deployed on a second device,
wherein the first computing power resource is configured to:
perform a data processing task assigned to itself to obtain target data; and
transmit a notification message to the second device to notify the second device to read the target data,
wherein the second device is configured to:
allocate, in response to the notification message and according to one or more properties of the target data carried in the notification message, a target memory in a memory of the second device;
generate a read request according to the one or more properties of the target data and the target memory; and
transmit the read request to the first device,
wherein the first device is configured to:
retrieve, in response to the read request and according to the one or more properties of the target data parsed from the read request, the target data from a memory of the first device;
copy the target data to a specified registered memory in the first device, wherein the specified registered memory is configured to store data to be written to other devices; and
write the target data stored in the specified registered memory to the target memory in the second device by performing a write operation, and
wherein the second computing power resource is configured to:
retrieve the target data from the target memory in the second device; and
perform a data processing task assigned to itself according to the target data,
wherein a completion queue (CO) is pre-created in the second device, and the CO is configured to store completed work requests,
wherein the first device is further configured to:
generate specified information, wherein the specified information is configured to notify the second device that the target data has been written to the target memory in the second device; and
write, in response to determining that the target data stored in the specified registered memory has been written to the target memory in the second device by performing a write operation, the specified information to the CQ in the second device, and
wherein the second device is further configured to:
query the CQ in the second device; and
determine whether the target data has been written to the target memory in the second device according to the specified information contained in the CQ.

2. (canceled)

3. The system according to claim 1, wherein the second device is further configured to:
generate, in response to determining that the target data has been written to the target memory in the second device according to the specified information contained in the CQ, an acknowledgement (ACK) message; and
transmit the ACK message to the first device to notify the first device to deallocate the memory occupied by the target data in the first device, and
wherein the first device is further configured to deallocate, in response to the ACK message transmitted by the second device, the memory occupied by the target data in the first device.

4. The system according to claim 1, wherein a completion queue (CQ) is pre-created in the second device, and the CQ is configured to store completed work requests,
wherein the first device is further configured to:
divide the target data according to a preset data length to obtain subdata segments;
generate, for each of the subdata segments, specified information corresponding to the subdata segment, wherein the specified information is configured to notify the second device that the subdata segment has been written to the target memory in the second device; and
write, in response to determining that each of the subdata segments from the target data stored in the specified registered memory has been written to the target memory in the second device in a sequence by performing write operations and in an order of the sequence for writing the subdata segments, the specified information corresponding to each of the subdata segments to the CQ in the second device, and
wherein the second device is further configured to:
query the CQ in the second device; and
determine, according to the specified information contained in the CQ, whether each of the subdata segments from the target data has been written to the target memory in the second device.

5. The system according to claim 4, wherein the second device is further configured to:
generate, in response to determining that the target data has been written to the target memory in the second device according to the specified information contained in the CQ, an acknowledgement (ACK) message; and
transmit the ACK message to the first device to notify the first device to deallocate memory occupied by the target data in the first device, and
wherein the first device is further configured to deallocate, in response to the ACK message transmitted by the second device, the memory occupied by the target data in the first device.

6. The system according to claim 1, wherein a first specified send memory and a second specified send memory are pre-allocated in the memory of the first device, and a first specified receive memory and a second specified receive memory are pre-allocated in the memory of the second device, and wherein the first specified send memory corresponds to the first specified receive memory, and the second specified send memory corresponds to the second specified receive memory,
wherein the first device is further configured to:
divide the target data into subdata segments;
copy, in response to determining that the first specified send memory and the first specified receive memory are both idle, a first subdata segment from the target data to the first specified send memory, and further write the first subdata segment to the first specified receive memory by performing a first write operation; and
copy, in response to determining that the second specified send memory and the second specified receive memory are both idle, a second subdata segment from the target data to the second specified send memory, and further write the second subdata segment to the second specified receive memory by performing a second write operation, and
wherein the second device is further configured to:
retrieve the first subdata segment from the first specified receive memory, and copy the retrieved first subdata segment to the target memory in the second device; and
retrieve the second subdata segment from the second specified receive memory, and copy the retrieved second subdata segment to the target memory in the second device.

7. The system according to claim 6, wherein the first device is further configured to:
obtain, by invoking a remote procedure call in advance, information of the first specified receive memory and the second specified receive memory allocated in the second device.

8. The system according to claim 1, wherein the one or more properties of the target data comprise a length of the target data, and
wherein the second device is further configured to:
determine a target length of the target memory according to the length of the target data carried in the notification message, wherein the target length is no less than the length of the target data; and
allocate, in the memory of the second device, the target memory of the target length.

9. The system according to claim 1, wherein the first device is further configured to:
activate a message bus in the first device;
determine, via the message bus in the first device, an identifier of the second device to receive the target data; and
transmit, in response to determining that an identifier of the first device is different from the identifier of the second device, the target data to the second device, and
wherein the second device is further configured to:
receive the target data sent by the first device;
activate a message bus in the second device;
determine, via the message bus in the second device, a message queue (MQ) corresponding to the second computing power resource;
insert the target data into the MQ corresponding to the second computing power resource; and
transmit, by polling the MQ corresponding to the second computing power resource with a polling thread invoked in the second device, the target data in the MQ to the second computing power resource.

10. The system according to claim 1, wherein the data processing task performed by the first computing power resource and the data processing task performed by the second computing power resource are determined based on respective computational subgraphs divided from a target computational graph, and wherein the target computational graph is determined based on an obtained target model,
wherein there is an upstream and downstream relationship between the data processing task performed by the first computing power resource and the data processing task performed by the second computing power resource, and the upstream and downstream relationship represents an input-output relationship between the respective computational subgraphs, and
wherein the target computational graph comprises at least one of a dynamic computational graph or a static computational graph.

11. A distributed communication method, applied to a first device, the method comprising:
retrieving target data from a memory of the first device, in response to a read request transmitted by a second device, according to one or more properties of target data parsed from the read request, wherein the read request is generated by the second device in response to a notification message transmitted by a first computing power resource deployed on the first device, according to one or more properties of target data carried in the notification message and a target memory allocated for the target data in the second device;
copying the target data to a specified registered memory in the first device, wherein the specified registered memory is configured to store data to be written to other devices; and
writing the target data stored in the specified registered memory to the target memory in the second device by performing a write operation, such that a second computing power resource deployed on the second device retrieves the target data from the target memory, and according to the retrieved target data, performs a data processing task assigned to the second computing power resource itself,
wherein a completion queue (CO) is pre-created in the second device, and the CQ is configured to store completed work requests, and
wherein writing the target data stored in the specified registered memory to the target memory in the second device by performing the write operation comprises:
dividing the target data according to a preset data length to obtain subdata segments;
generating, for each of the subdata segments, specified information corresponding to the subdata segment, and the specified information is configured to notify the second device that the subdata segment has been written to the target memory in the second device; and
writing, in response to determining that each of the subdata segments from the target data stored in the specified registered memory has been written to the target memory in the second device in a sequence by performing write operations and in an order of the sequence for writing the subdata segments, the specified information corresponding to each of the subdata segments to the CQ in the second device, such that the second device determines whether each of the subdata segments from the target data has been written to the target memory in the second device by querying the specified information contained in the CO in the second device.

12. (canceled)

13. The method according to claim 11, wherein a first specified send memory and a second specified send memory are pre-allocated in the memory of the first device, wherein a first specified receive memory and a second specified receive memory are pre-allocated in the memory of the second device, and wherein the first specified send memory corresponds to the first specified receive memory, and the second specified send memory corresponds to the second specified receive memory, and
wherein the method further comprises:
dividing the retrieved target data into subdata segments;
copying, in response to determining that the first specified send memory and the first specified receive memory are both idle, a first subdata segment from the target data to the first specified send memory, and further writing the first subdata segment to the first specified receive memory by performing a first write operation, such that the second device retrieves the first subdata segment from the first specified receive memory and copies the retrieved first subdata segment to the target memory in the second device; and
copying, in response to determining that the second specified send memory and the second specified receive memory are both idle, a second subdata segment from the target data to the second specified send memory, and further writing the second subdata segment to the second specified receive memory by performing a second write operation, such that the second device retrieves the second subdata segment from the second specified receive memory, and copies the retrieved second subdata segment to the target memory in the second device.

14. The method according to claim 11, further comprising:
activating a message bus in the first device, and then
determining an identifier of the second device to receive the target data with the message bus in the first device;
transmitting, in response to determining that an identifier of the first device is different from the identifier of the second device, the target data to the second device, such that the second device performs operations comprising:
receiving the target data sent by the first device;
activating a message bus in the second device;
determining a message queue (MQ) corresponding to the second computing power resource with the message bus in the second device;
inserting the target data into the MQ corresponding to the second computing power resource; and
transmitting, by polling the MQ corresponding to the second computing power resource with a polling thread invoked in the second device, the target data in the MQ to the second computing power resource.

15. A distributed communication method, applied to second device, the method comprising:
allocating, in response to a notification message transmitted by a first computing power resource deployed on a first device, according to one or more properties of target data carried in the notification message, target memory to store the target data in a memory of the second device, wherein the target data is obtained by the first computing power resource performing a data processing task assigned to itself, and the notification message is generated according to the target data and sent by the first computing power resource;
generating a read request, according to the one or more properties of the target data and the target memory; and
transmitting the read request to the first device, such that the first device performs operations comprising:
retrieving the target data from a memory of the first device according to the one or more properties of the target data parsed from the read request,
copying the target data to a specified registered memory in the first device, wherein the specified registered memory is configured to store data to be written to other devices, and
writing the target data stored in the specified registered memory to the target memory in the second device by performing a write operation, such that a second computing power resource deployed on the second device performs a data processing task assigned to itself based on the target data in the target memory,
wherein a completion queue (CO) is pre-created in the second device, and the CO is configured to store completed work requests, and the method further comprises:
query the CO in the second device; and
determine whether the target data has been written to the target memory in the second device according to the specified information contained in the CQ;
wherein the specified information is generated by the first device, wherein the specified information is configured to notify the second device that the target data has been written to the target memory in the second device; and in response to determining that the target data stored in the specified registered memory has been written to the target memory in the second device by performing a write operation, the specified information is written by the first device to the CO in the second device.

16. The method according to claim 15, wherein allocating the target memory to store the target data in the memory of the second device comprises:
determining a target length of the target memory according to a length of the target data carried in the notification message, and the target length is no less than the length of the target data; and
allocating, in the memory of the second device, the target memory having the target length.

17. The method according to claim 15, further comprising:
receiving the target data transmitted by the first device;
activating a message bus in the second device;
determining a message queue (MQ) corresponding to the second computing power resource with the message bus in the second device;
inserting the target data into the MQ corresponding to the second computing power resource; and
transmitting, by polling the MQ corresponding to the second computing power resource with a polling thread invoked in the second device, the target data in the MQ to the second computing power resource, such that the second computing power resource performs a data processing task assigned to itself based on the target data.

18. A non-transitory computer readable storage medium storing machine-readable instructions executable by at least one processor to perform the method as described in claim 11.

19. A non-transitory computer readable storage medium storing machine-readable instructions executable by at least one processor to perform the method as described in claim 15.

20. An electronic device comprising at least one processor and at least one memory storing machine-readable instructions executable by the at least one processor to perform the method as described in claim 11.
